(19) United States
(12) Patent Application Publication
(10) Pub. No.: US 2010/0088615 A1
(43) Pub. Date: Apr. 8, 2010

(54) INFORMATION PROCESSING DEVICE, CONTROL METHOD, AND RECORDING MEDIUM THAT RECORDS CONTROL PROGRAM

(75) Inventor: Miho MATSUNOBU, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/571,490

(22) Filed: Oct. 1, 2009

(30) Foreign Application Priority Data
Oct. 2, 2008 (JP) 2008-257328

(51) Int. Cl. G06F 3/01

(52) U.S. Cl. 715/760

(57) ABSTRACT

An information processing device includes a browsing unit that displays provision information provided from a server on a display unit, a highlighted display unit that adds a highlighted display to the provision information displayed on the display unit, a coordinate information calculation unit that analyzes an area added with the highlighted display of the provision information and calculates coordinate information of the area added with the highlighted display of the provision information, an identification information processing unit that processes identification information by adding the coordinate information to identification information indicating a storage location of the provision information in the server, and a transmitting unit that transmits identification information that includes the coordinate information to another device that receives provision information specified by the identification information from the server.

### CROSS-REFERENCE TO RELATED APPLICATIONS

This application is based upon and claims the benefit of priority of the prior Japanese Patent Application No. 2008-257328, filed on Oct. 2, 2008, the entire contents of which are incorporated herein by reference.

### BACKGROUND

In recent years, the Internet communication technique called World Wide Web has been used as a standard technique. In the WWW, an information provider provides a host computer called a WWW server. A client computer of an information viewer accesses the host computer by using a program called a WWW browser. Then the client computer of the information viewer obtains desired information from the accessed host computer. The information obtained from the host computer is written in a written language called Hyper Text Markup Language (HTML). The WWW browser interprets HTML. The HTML is interpreted by the WWW browser and is displayed as a web page on a display device.

### SUMMARY

An information processing device includes a browsing unit that displays provision information provided from a server on a display unit, a highlighted display unit that adds a highlighted display to the provision information displayed on the display unit, a coordinate information calculation unit that analyzes an area added with the highlighted display of the provision information and calculates coordinate information of the area added with the highlighted display of the provision information, an identification information processing unit that processes identification information by adding the coordinate information to identification information indicating a storage location of the provision information in the server, and a transmitting unit that transmits identification information that includes the coordinate information to another device that receives provision information specified by the identification information from the server.

A control method in an information processing device including displaying provision information provided from a server on a display unit, adding a highlighted display to one or more areas of the provision information displayed on the display unit, analyzing the one or more areas added with the highlighted display of the provision information and calculating coordinate information of the one or more areas added with the highlighted display of the provision information, processing identification information by adding the coordinate information to identification information indicating a storage location of the provision information in the server, and transmitting the identification information that includes the coordinate information to another device that receives the provision information specified by the identification information from the server.

The object and advantages will be realized and attained by means of the elements and combinations particularly pointed out in the claims. It is to be understood that both the foregoing general description and the following detailed description are exemplary and explanatory and are not restrictive of the various embodiments, as claimed.

### BRIEF DESCRIPTION OF THE DRAWINGS

FIG. 1 is a block diagram illustrating a system configuration.

FIG. 2 is a diagram illustrating a hardware configuration of a user device 1.

FIG. 3 is a diagram illustrating a hardware configuration of a user device 2.

FIG. 4 is a functional block diagram of the user device 1.

FIG. 5 is a functional block diagram of the user device 2.

FIG. 6 is a flowchart illustrating adding processing of highlighted display, generating processing of an exclusive URL, and transmitting processing of the exclusive URL.

FIG. 7 is a diagram illustrating an example of a display image on a web page added with the highlighted display.

FIG. 8 is a flowchart illustrating calculating processing of coordinate information corresponding to an area added with the highlighted display is added.

FIG. 9 is a flowchart illustrating adding processing of the highlighted display by the user device 2 and displaying processing of the display image of the web page added with the highlighted display.

FIG. 10 is a diagram illustrating an example of the display image of the web page added with the highlighted display.

### DETAILED DESCRIPTION OF THE PREFERRED EMBODIMENTS

Based on the diagrams, description will be made below of a system according to a best mode for carrying out the present invention (hereinafter referred to as “embodiment”). The configuration of the embodiment described below is an example, and the present disclosure is not limited to the configuration of the embodiment.

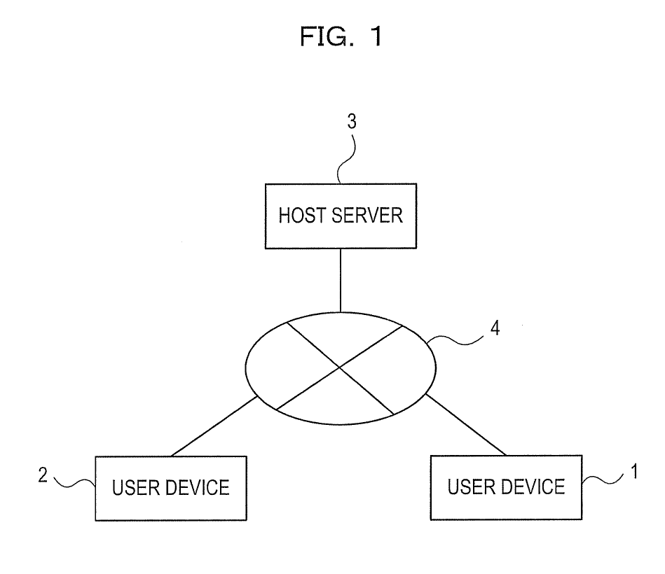

FIG. 1 is a block diagram illustrating a system configuration of the present embodiment. The system includes a user device 1, a user device 2, and a host server 3. The user device 1 and the host server 3 exchange information with each other through a network 4. Furthermore, the user device 2 and the host server 3 exchange information with each other through the network 4. In the host server 3, a web site is provided to provide the user device 1 and the user device 2 with specified information.

The user device 1 and the user device 2 are each an information processing device such as, for example, a personal computer, a Personal Digital Assistant (PDA), a mobile phone, or a Consumer Electronics (CE) device connectable to the network 4.

The host server 3 is an information management device such as, for example, a personal computer, a work station, and/or a mainframe that is connectable to the network 4.

The network 4 is, for example, the Internet or Local Area Network (LAN). Furthermore, the network 4 may be composed of a communication line such as a telephone line, an exclusive line, an optic communication network, and a communication satellite, or the like.

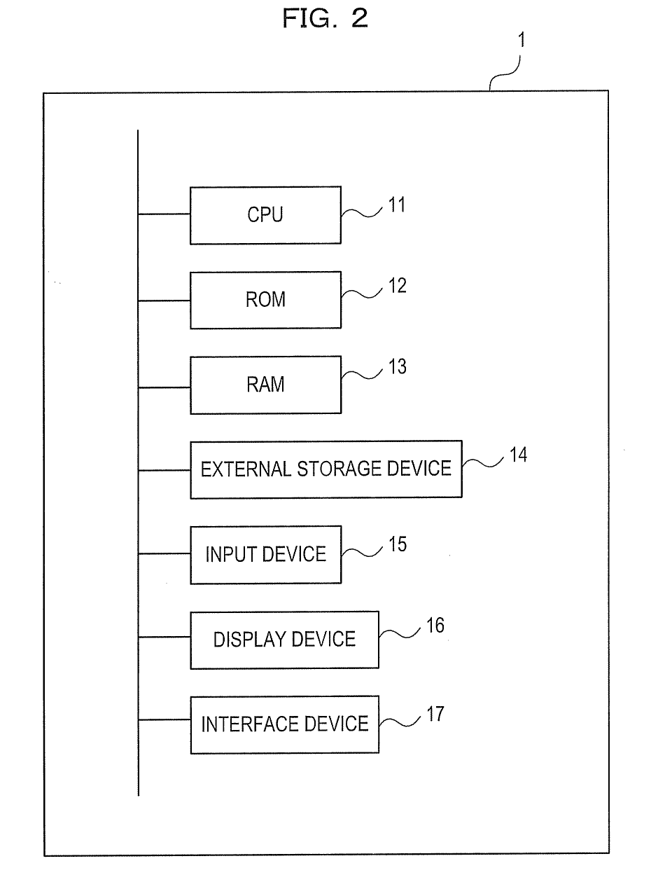

FIG. 2 is a diagram illustrating a hardware configuration of the user device 1 of a case where the user device 1 is achieved as a personal computer.

The user device 1 includes a Central Processing Unit (CPU) 11, a Read Only Memory (ROM) 12, a Random Access Memory (RAM) 13, an external storage device 14, an input device 15, a display device 16, and an interface device 17. These are connected to each other through a bus.

The CPU 11 performs various processing according to a program stored in the ROM 12. The CPU 11 establishes a communication line to connect the user device 2 and the host server 3 through the interface device 17. The interface device 17 includes a communication device such as, for example, a modem and a terminal adaptor, or the like, and controls the communication with the user device 2 and the host server 3.

The ROM 12 stores programs, parameters, and the like to be used by the CPU 11 to perform various processing. The ROM 12 stores, for example, a communication program for establishing and maintaining the communication with the user device 2 or the host server 3.

The RAM 13 temporarily stores data necessary for operations of the CPU 11, a program of an application to be executed by the CPU 11, and the like.

The external storage device 14 stores a program to be loaded into the RAM 13. The external storage device 14 further stores data to be proceeded by the CPU 11.

The input device 15 is operated to input a specified command or necessary data. The input device 15 may be, for example, a keyboard, a mouse, a pointing device, a wireless remote controller, or the like.

The display device 16 displays the data to be proceeded by the CPU 11 and the data to be stored in the RAM 13. The display device 16 may be, for example, a liquid crystal display device, a plasma display panel, a Cathode Ray Tube (CRT), an Electroluminescence, or the like.

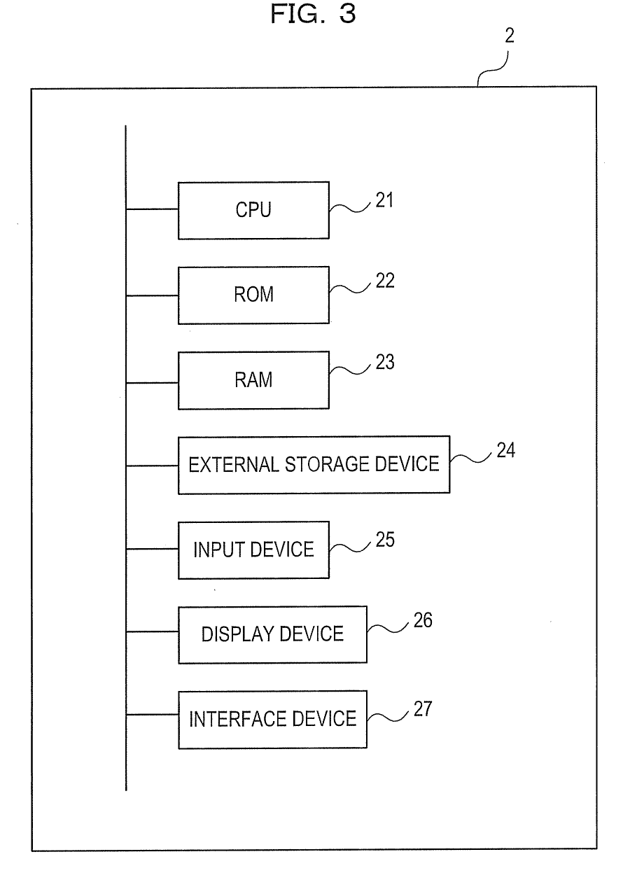

FIG. 3 is a diagram illustrating a hardware configuration of the user device 2 of a case where the user device 2 is achieved as a personal computer. The user device 2 includes a CPU 21, a ROM 22, a RAM 23, an external storage device 24, an input device 25, a display device 26, and an interface device 27. Since the user device 2 has the same hardware configuration as of the user device 1, the description is omitted.

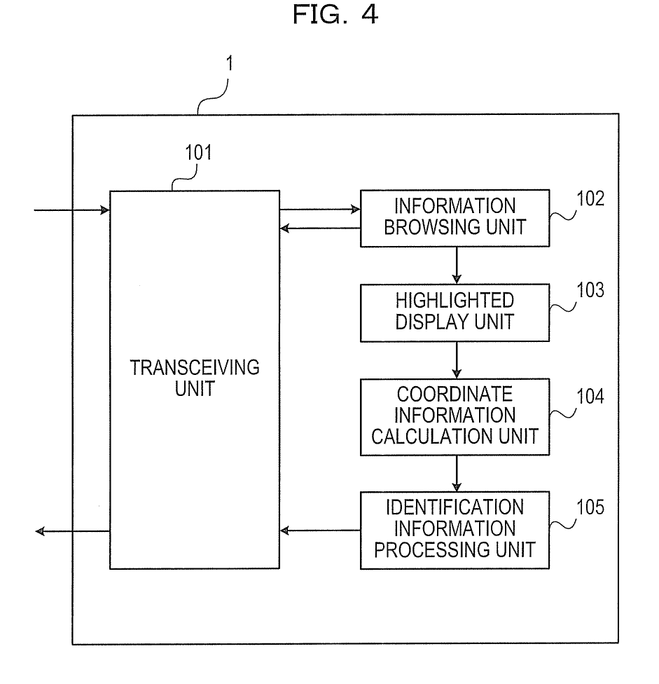

FIG. 4 is a functional block diagram of the user device 1. The user device 1 includes a transceiving unit 101, an information browsing unit 102, a highlighted display unit 103, a coordinate information calculation unit 104, and an identification information processing unit 105. Each of the above-described units may be achieved by a computer that includes the CPU 11, the ROM 12, and the RAM 13, and by programs and the like to be executed on each device and computer.

Functions as the information browsing unit 102, the highlighted display unit 103, and the identification information processing unit 105 may be achieved if an exclusive browser stored in the ROM 12 is executed by the CPU 11, the RAM 13, and the like.

Functions as the information browsing unit 102 and the highlighted display unit 103 may be achieved if the exclusive browser stored in the ROM 12 is executed by the CPU 11, the RAM 13, and the like. A function as the identification information processing unit 105 may be achieved if an exclusive application stored in the ROM 12 is executed by the CPU 11, the RAM 13, and the like.

The transceiving unit 101 transmits various information to the user device 2 and the host server 3 through the network 4. The transceiving unit 101 receives various information transmitted from the user device 2 and the host server 3 through the network 4.

The information browsing unit 102 connects the user device 1 to the network 4 according to a specification from a user through the input device 15. The information browsing unit 102 uses a protocol written in a Uniform Resource Locator (URL) that is specified or input by the user through the input device 15 to connect the user device 1 to the host server 3 in which the web site specified by the URL is opened. The URL includes a protocol for accessing the web site, the name of the server in which the web site is opened, and a directory and a file name storing the web page. The URL corresponds to identification information. The web page corresponds to provision information.

The information browsing unit 102 receives, from the host server 3, the web page specified by the URL specified or input by the user through the input device 15. The information browsing unit 102 displays an image on the display device 16 based on the web page received from the host server 3. The web page is written in a markup language format, for example, Hypertext Markup Language (HTML), Extensible Markup Language, or the like.

According to the specification from the user through the input device 15, the highlighted display unit 103 adds highlighted display to a display image displayed by the display device 16 based on the web page. According to the specification from the user, the highlighted display unit 103 displays the display image of the web page added with the highlighted display on the display device 16.

The coordinate information calculation unit 104 analyzes the image inside an area added with the highlighted display in the display image of the web page. The coordinate information calculation unit 104 calculates coordinate information corresponding to the area added with the highlighted display in the display image of the web page. For example, if a web page is written in HTML, information indicating a line number of HTML source code corresponds to the coordinate information.

The identification information processing unit 105 processes the URL by adding the coordinate information to the URL specified or input by the user through the input device 15. The identification information processing unit 105 adds the information indicating a setting method of the highlighted display to the URL added with the coordinate information.

The transceiving unit 101 transmits the URL added with the coordinate information to the user device 2 through the network 4. The transceiving unit 101 transmits the URL added with the coordinate information and the information indicating the setting method of the highlighted display to the user device 2 through the network 4. The transceiving unit 101 may transmit an e-mail attached with the URL, added with the coordinate information, to the user device 2. The transceiving unit 101 may transmit an e-mail attached with the URL, added with the coordinate information and the information indicating the setting method of the highlighted display, to the user device 2.

When the coordinate information is added to the URL that is specified or input by the user through the input device 15, the information browsing unit 102 and the highlighted display unit 103 perform the following processing (1) to (5).
(1) The information browsing unit 102 receives, from the host server 3, the web page specified by the URL that is specified or input by the user through the input device 15.
(2) The information browsing unit 102 transmits the web page received from the host server 3 to the highlighted display unit 103.
(3) The highlighted display unit 103 receives the web page from the information browsing unit 102.
(4) The highlighted display unit 103 adds the highlighted display to the display image of the web page by referring the coordinate information added to the URL.
(5) The highlighted display unit 103 displays, on the display device 16, the display image of the web page added with the highlighted display.

If the information indicating the setting method of the highlighted display is further added to the URL that is specified or input the by the user through the input device 15, the highlighted display unit 103 performs the following processing (6) to (8) instead of the above-described processing (4) and (5).
(6) The highlighted display unit 103 adds the highlighted display according to the information indicating the setting method of the highlighted display to the display image of the web page by referring the coordinate information added to the URL and the information indicating the setting method of the highlighted display.
(7) The highlighted display unit 103 displays, on the display device 16, the display image of the web page added with the highlighted display according to the information indicating the setting method of the highlighted display.
(8) The highlighted display unit 103 displays, on the display device 16, the information related to a displaying method of the highlighted display.

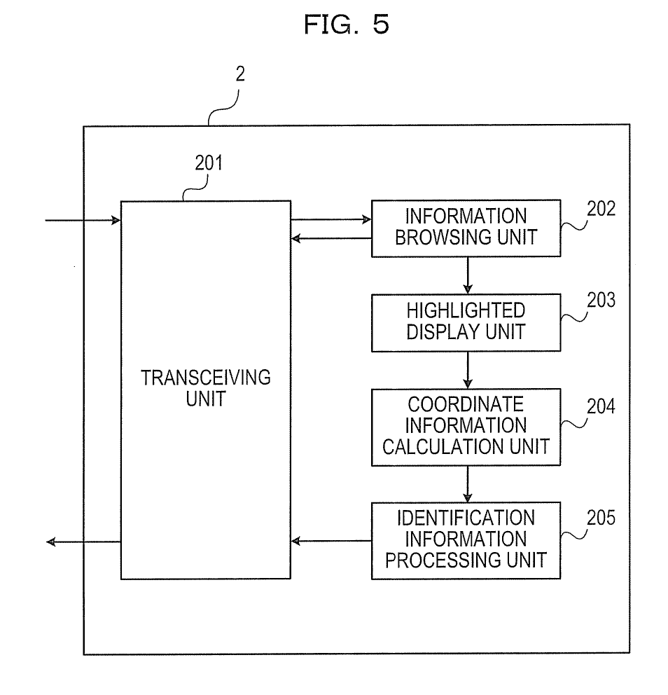

FIG. 5 is a functional block diagram of the user device 2. The user device 2 includes a transceiving unit 201, an information browsing unit 202, a highlighted display unit 203, a coordinate information calculation unit 204, and an identification information processing unit 205. Each of the above-described functional units may be achieved by a computer, which includes a CPU 21, a ROM 22, a RAM 23, and the like, and by programs and the like to be executed on each device and computer. Functions as the information browsing unit 202, the highlighted display unit 203, the coordinate information calculation unit 204, and the identification information processing unit 205 may be achieved if an exclusive browser stored in the ROM 22 is executed by the CPU 21, and the RAM 23, and the like.

Functions as the information browsing unit 202, the highlighted display unit 203, and the identification information processing unit 205 may be achieved if the exclusive browser stored in the ROM 22 is executed by the CPU 21, the RAM 23, and the like.

Functions as the information browsing unit 202 and the highlighted display unit 203 may be achieved if the exclusive browser stored in the ROM 22 is achieved by the CPU 21, the RAM 23, and the like. A function as the identification information processing unit 205 may be achieved if an exclusive application stored in the ROM 22 is executed by the CPU 21, the RAM 23, and the like.

Since the user device 2 has the same functional configuration as of the user device 1, the description is omitted.

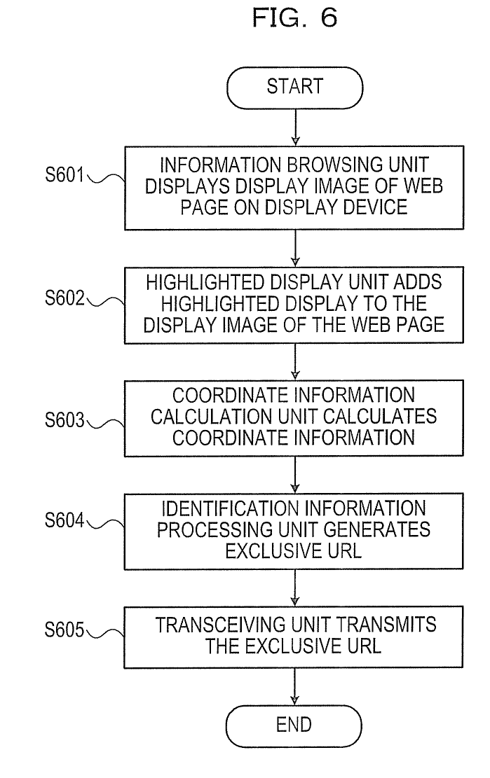

Next, with reference to FIG. 6, description will be made of processing of the user device 1 for adding the highlighted display to the display image of the web page and for transmitting the generated exclusive URL to the user device 2. FIG. 6 is a flowchart illustrating a flow of adding processing of the highlighted display, generating processing of an exclusive URL, and transmitting processing of the exclusive URL.

Here, the exclusive URL may include the coordinate information. The exclusive URL may further include the coordinate information and the information indicating the setting method of the highlighted display. That is, the exclusive URL may be a URL proceeded by adding the coordinate information to a URL or may be a URL proceeded by adding the coordinate information and the information indicating the setting method of the highlighted display to a URL.

The user device 1 starts the processing illustrated in FIG. 6 by receiving specification or input of the URL from the user through the input device 15. For example, when a URL is input in a URL input column displayed on the display device 16, the processing illustrated in FIG. 6 may be started.

The information browsing unit 102 receives, from the host server 3, the web page that is specified or input by the user through the input device 15. The information browsing unit 102 displays the display image of the web page, received from the host server 3, on the display device 16.

Next, the highlighted display unit 103 adds the highlighted display to the display image of the web page according to the specification by the user through the input device 15.

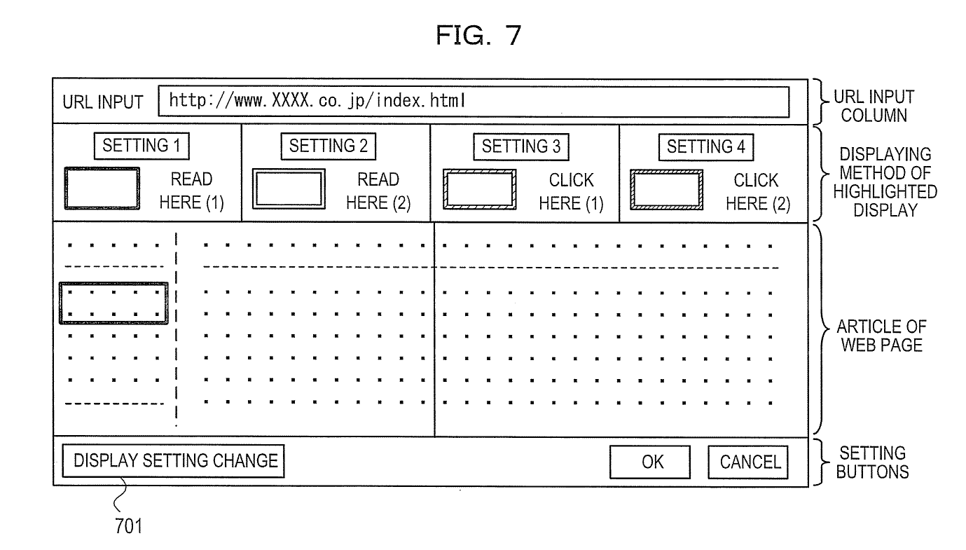

FIG. 7 is a diagram illustrating an example in a case where the highlighted display is added to the web page by the highlighted display unit 103 and where the display image of the web page added with the highlighted display is displayed on the display device 16.

The URL that is specified or input by the user through the input device 15 is input in the URL input column illustrated in FIG. 7.

As for the displaying method of the highlighted display illustrated in FIG. 7, an icon that includes the information indicating a type of the highlighted display and the information indicating an action for requesting an opposite-side user to perform is set. The type of the highlighted display includes a shape, a pattern, and a color of the highlighted display.

The opposite-side user is a user of the user device 2 who receives the exclusive URL. The action requesting the opposite-side user to perform is, for example, to read a text with the highlighted display in the display image of the web page. Furthermore, the action requesting the opposite-side user to perform is, for example, to see the highlighted shape and image in the display image of the web page. Moreover, the action requesting the opposite-side user to perform is, for example, to click (press) a highlighted part in the display image of the web page.

By pressing a display setting change button 701 illustrated in FIG. 7, the type of the highlighted display and the action requesting the opposite-side user to perform may be changed on a display setting change screen (not illustrated).

Through the input device 15, the user selects the type of the icon that is set to the displaying method of the highlighted display and specifies an area where information that is desired to be transmitted to the opposite-side user in the display image of the web page is displayed. For example, the user drags a part that is desired to be highlighted in the display image of the web page displayed on the display device 16 through the input device 15.

The highlighted display unit 103 recognizes that the part dragged on the display image of the web page is the area that is specified to be highlighted. The highlighted display unit 103 adds the highlighted display to the display image of the web page according to the type of the selected icon and the area specified to be highlighted. FIG. 7 illustrates a case where the user selects a setting 1 as a type of the icon and where the highlighted display is added to the display image of the web page.

FIG. 6 will be described again. The coordinate information calculation unit 104 analyzes the image inside the area added with the highlighted display in the display image of the web page and calculates the coordinate information corresponding to the area added with the highlighted display (S603).

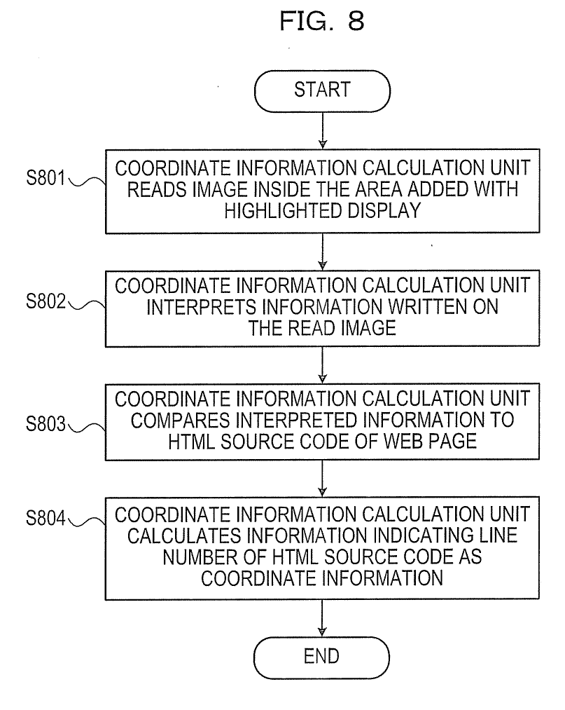

Here, detailed description will be made of a case where the coordinate information calculation unit 104 analyzes the image inside the area added with the highlighted display in the display image of the web page and calculates the coordinate information corresponding to the area added with the highlighted display. FIG. 8 is a flowchart illustrating a flow of a case where the coordinate information calculation unit 104 analyzes the image inside the area added with the highlighted display in the display image of the web page and calculates the coordinate information corresponding to the area added with the highlighted display.

The coordinate information calculation unit 104 reads the image inside the area added with the highlighted display in the display image of the web page (S801). The coordinate information calculation unit 104 analyzes the read image to interpret the information (for example, characters or texts) written on the read image (S802).

The coordinate information calculation unit 104 analyzes the read image to interpret the information (for example, characters or texts) written on the read image (S802). The coordinate information calculation unit 104 determines which part of the HTML source code of the web page is highlighted in the display image of the web page and calculates information indicating a line number of the HTML source code as the coordinate information (S804).

FIG. 6 will be described again. The identification information processing unit 105 generates an exclusive URL by adding the coordinate information and the information indicating the setting method of the highlighted display to the URL that is specified or input by the user through the input device 15 (S604). The identification information processing unit 105 may generate an exclusive URL by adding only the coordinate information to the URL that is specified or input by the user through the input device 15.

For example, if the URL specified or input by the user through the input device 15 is “http://www.XXXX.co.jp/index.html,” the identification information processing unit 105 may generate “http://XXXX.co.jp/index.html&line125?line135&set1?red” as the exclusive URL.

The information of the exclusive URL, “line125?line135,” is the coordinate information. If the coordinate information is “line125?line135,” the exclusive URL indicates that the line number of the HTML source code corresponding to the image inside the area added with the highlighted display in the display image of the web page is 125 to 135.

The information of the exclusive URL, “set1?red,” indicates the setting method of the highlighted display. The information of the exclusive URL, “set1,” indicates that the setting 1 of the displaying method of the highlighted display illustrated in FIG. 7, and “red” of the exclusive URL indicates the type of the color of the highlighted display.

The transceiving unit 101 transmits the exclusive URL to the user device 2 through the network 4 (S605). The transceiving unit 201 of the user device 2 receives the exclusive URL through the network 4.

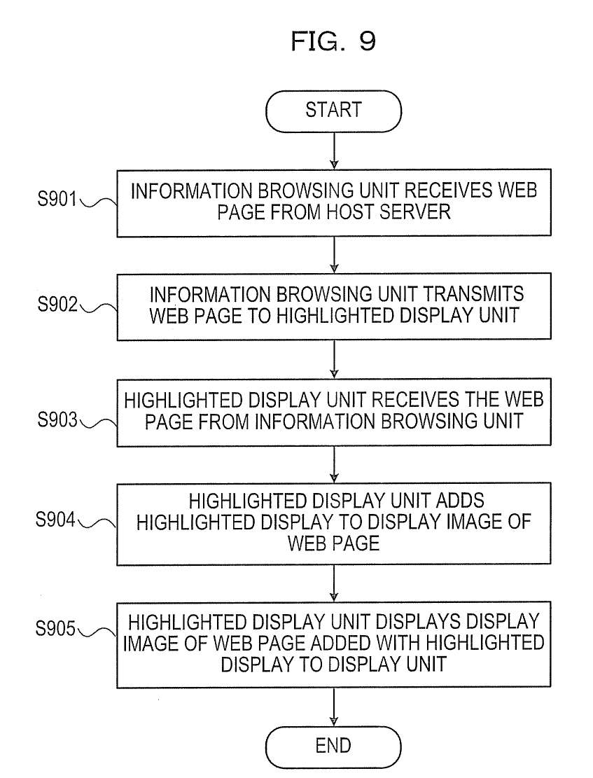

Next, with reference to FIG. 9, description will be made of processing in which the user device 2 displays the display image of the web page added with the highlighted display on the display device 26. FIG. 9 is a flowchart illustrating a flow of adding processing of the highlighted display by the user device 2 and displaying processing of the display image of the web page added with the highlighted display. As for the processing illustrated in FIG. 9, the user device 2 is assumed to receive the exclusive URL from the user device 1.

The user device 2 starts the processing illustrated in FIG. 9 by receiving input of the exclusive URL from the user through the input device 25. For example, if the exclusive URL is input in the URL input column displayed on the display device 26, the processing illustrated in FIG. 9 may be started.

The information browsing unit 202 receives, from the host server 3, the web page specified by the exclusive URL that is input by the user through the input device 25 (S901).

The information browsing unit 202 transmits the web page received from the host server 3 to the highlighted display unit 203 (S902). The highlighted display unit 203 receives the web page from the information browsing unit 202 (S903).

The highlighted display unit 203 refers to the coordinate information added to the exclusive URL and the information indicating the setting method of the highlighted display. The highlighted display unit 203 adds the highlighted display to the display image of the web page according to the coordinate information added to the exclusive URL and the information indicating the setting method of the highlighted display (S904).

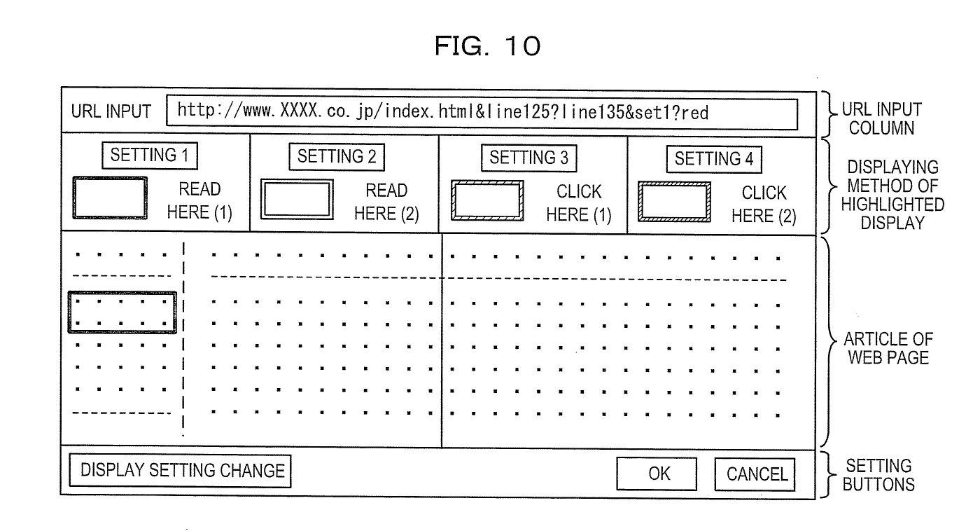

The highlighted display unit 203 displays the display image of the web page added with the highlighted display on the display device 26 (S905). The highlighted display unit 203 displays, on the display device 26, the icon that includes the information indicating the type of the highlighted display and the information indicating an action for requesting the opposite-side user to perform. FIG. 10 is a diagram illustrating an example of a case where the display device 26 displays the display image of the web page added with the highlighted display and displays the icon that includes the information indicating the type of the highlighted display and the information indicating the action for requesting the opposite-side user to perform.

In FIG. 10, “http://XXXX.co.jp/index.html&line125?line135&set1?red” is input as the exclusive URL by the user through the input device 25. The highlighted display unit 203 adds the highlighted display to the display image of the web page corresponding to the lines 125 to 135 of the HTML source code by referring to “line125?line135” of the exclusive URL. By referring to “set1” of the exclusive URL, the highlighted display unit 203 adds the highlighted display to the display image of the web page by the method that is set to the setting 1 of the displaying method of the highlighted display illustrated in FIG. 10. The highlighted display unit 203 adds the highlighted display in red color to the display image of the web page by referring to “red” of the exclusive URL.

The highlighted display unit 203 may display the display image of the web page added with the highlighted display on the display device 26 in such a way that the area added with the highlighted display of the display image of the web page is the uppermost part or near the upper part of the display image of the web page. Accordingly, even if the screen of the display device 26 is small, the area added with the highlighted display of the display image of the web page may be surely displayed on the display device 26.

The processing illustrated in FIG. 9 is an example of a case where the exclusive URL is added with the coordinate information and the information indicating the setting method of the highlighted display. If the exclusive URL is not added with the information indicating the setting method of the highlighted display, the following processing is performed instead of the processing of S904 and S905 in FIG. 9.

The highlighted display unit 203 refers to the coordinate information added to the exclusive URL. According to the coordinate information added to the exclusive URL, the highlighted display unit 203 adds the highlighted display to the display image of the web page. The highlighted display unit 203 displays the display image of the web page added with the highlighted display on the display device 26. In this case, the highlighted display unit 203 does not display the icon that includes the information indicating the type of the highlighted display and the information indicating the action for requesting the opposite-side user to perform on the display device 26.

According to the present embodiment, the user is capable of transmitting specific information in the web page more accurately without depending on an environment of the information device used by the opposite-side user. Furthermore, the user is capable of transmitting the specific information in the web page more accurately without transmitting description of a case where the highlighted display is added to the display image of the web page to the opposite-side user.

The present disclosure may employ a computer, another device, a machine, or the like executing one of the above-described processing. Furthermore, the present disclosure may employ a program for making a computer, another device, a machine, or the like achieve one of the above-described functions. Moreover, the present disclosure may employ a recording medium that records such a program that a computer or the like can read.

### (Computer-Readable Recording Medium)

A program for making a computer achieve one of the above-described functions may be recorded in a computer-readable recording medium. Then the function may be provided by allowing the computer or the like to read and execute the program recorded in the recording medium. In this case, the computer-readable recording medium stores information of data, programs, or the like electrically, magnetically, optically, mechanically, or by using chemical functioning and the information may be read by the computer or the like. As such a recording medium removable from the computer, for example, a flexible disk, optic magnetic disk, a CD-ROM, a CD-R/W, a DVD, a DAT, an 8 mm tape, a memory card, and the like are applicable. Furthermore, a recording medium that is fixed to a computer or the like may be hard disk, a ROM, or the like.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing device, comprising:
a browsing unit that displays provision information provided from a server on a display unit;
a highlighted display unit that adds a highlighted display to one or more areas of the provision information displayed on the display unit;
a coordinate information calculation unit that analyzes the one or more areas added with the highlighted display of the provision information and calculates coordinate information of the one or more areas added with the highlighted display of the provision information;
an identification information processing unit that processes identification information by adding the coordinate information to identification information indicating a storage location of the provision information in the server; and
a transmitting unit that transmits identification information that includes the coordinate information to another device that receives provision information specified by the identification information from the server.

2. The information processing device according to claim 1, wherein the identification information processing unit further adds information indicating a setting method of the highlighted display to the identification information.

3. The information processing device according to claim 1, wherein the coordinate information indicates a location corresponding to one or more areas added with the highlighted display in the data if the provision information is written in specified format data.

4. A control method in an information processing device, comprising:
displaying provision information provided from a server on a display unit;
adding a highlighted display to one or more areas of the provision information displayed on the display unit;
analyzing the one or more areas added with the highlighted display of the provision information and calculating coordinate information of the one or more areas added with the highlighted display of the provision information;
processing identification information by adding the coordinate information to identification information indicating a storage location of the provision information in the server; and
transmitting the identification information that includes the coordinate information to another device that receives the provision information specified by the identification information from the server.

5. The control method in the information processing device according to claim 4, wherein the processing further adds information indicating a setting method of the highlighted display to the identification information.

6. The control method of the information processing device according to claim 4, wherein the coordinate information indicates a location corresponding to one or more areas added with the highlighted display in the data if the provision information is written in specified format data.

7. A computer-readable recording medium that records a control program of an information processing device executed by an information processing device, the program executing a method comprising:
displaying provision information provided from a server on a display unit;
adding a highlighted display to one or more areas of the provision information displayed on the display unit;
analyzing the one or more areas added with the highlighted display of the provision information and calculating coordinate information of the one or more areas added with the highlighted display of the provision information;
processing identification information by adding the coordinate information to identification information indicating a storage location of the provision information in the server; and
transmitting the identification information that includes the coordinate information to another device that receives the provision information specified by the identification information from the server.

8. The computer-readable recording medium that records the control program according to claim 7, wherein the processing further adds information indicating a setting method of the highlighted display to the identification information.

9. The computer-readable recording medium that records the control program according to claim 7, wherein the coordinate information indicates a location corresponding to one or more areas added with the highlighted display in the data if the provision information is written in specified format data.

10. An information transfer system, comprising:
a first user device; and
a second user device, wherein the first user device and the second user device are connected each other through a server and a network,
wherein the first user device includes:
a first browsing unit that displays provision information provided from the server on a display unit;
a first highlighted display unit that adds a highlighted display to one or more areas of the provision information displayed on the display unit;
a coordinate information calculation unit that analyzes the one or more areas added with the highlighted display and calculates coordinate information of the one or more areas added with the highlighted display of the provision information;
an identification information processing unit that processes identification information by adding the coordinate information to identification information indicating a storage location of the provision information in the server; and
a transmitting unit that transmits the identification information that includes the coordinate information to the second user device,
and wherein the second user device includes:
a receiving unit that receives the identification information that includes the coordinate information;
a second browsing unit that receives the provision information specified by the identification information by accepting input of the identification information; and
a second highlighted display unit that displays the one or more areas of the provision information added with the highlighted display on the display unit according to the coordinate information.
